(19) United States
(12) Patent Application Publication
(10) Pub. No.: US 2004/0124291 A1
(43) Pub. Date: Jul. 1, 2004

(54) Road machine with a means for discharging material and comprising a device for verifying the discharge function

(76) Inventors: Allan Northeved, Rudsvedby (DK); Carsten Langkjaer, Varlose (DK)

Correspondence Address: Cooper & Dunham, 1185 Avenue of the Americas, New York, NY, 10036, US

(21) Appl. No.: 10/416,866

(22) PCT Filed: Nov. 13, 2001
(86) PCT No.: PCT/DK01/00747

(30) Foreign Application Priority Data
Nov. 13, 2000 (DK) PA 2000 01695

(51) Int. Cl. A01C 3/06

(52) U.S. Cl. 239/650

(57) ABSTRACT

A road machine for preventing slippery roads and comprising a means for discharging and spreading material for preventing slippery roads as well as a device for verifying the discharge function. The verifying device comprises a microwave transmitter/receiver (10) and a signal processing circuit (20), which in response to the received signal can detect the presence of discharged material for preventing slippery roads. In this manner it is possible to carry out a contact-free verification of the discharge function of particles moving at a specific speed and in a specific direction.

### TECHNICAL FIELD

The invention relates to a road machine for preventing slippery roads and comprising a means for discharging and spreading material for preventing slippery roads as well as a transmitter/receiver device for microwaves verifying the discharge function.

### BACKGROUND ART

It is known to detect material being discharged by placing a small bar at the intended discharge location. This bar is caused to vibrate by material being discharged, and this vibration can be detected by means of a vibrometer. However, the salt being discharged may adhere to the bar, and therefore the bar must be cleaned at regular intervals. It is, of course, desired to avoid such a cleaning. In addition, a predetermined degree of wear and tear and consequently a limited life of the bar apply. Furthermore, the bar interferes with the spreading image.

### BRIEF DESCRIPTIONS OF THE INVENTION

The object of the invention is therefore to demonstrate how it is possible to carry out a contact-free verification of the discharge function of a road machine. However, the object is only to detect particles moving at a specific speed and in a specific direction.

A road machine of the above type is according to the invention characterised in that the transmitter/receiver device is adapted to perform a Doppler measurement of the signal reflected by the optionally discharged material, whereby signal processing means are provided for detecting the presence of discharged material on the basis of the Doppler displacement of the frequency of the received reflected signal, said optionally discharged material moving in a predetermined direction within a predetermined speed space. In this manner it is possible to carry out a contact-free verification of the discharge function of particles moving at a specific speed and in a specific direction. Furthermore, such a verifying device presents an almost indefinite life.

EP-A-0300580 discloses an agricultural machine for spreading material, such as fertilizers by means of a rotating spreading disc. This known machine comprises an electronic transmitter/receiver means for determining whether the material is in fact being discharged. However, a Doppler measurement has not been described.

Moreover, the road machine according to the invention may be structured in such a manner that the Doppler displacement can only be measured provided the frequency of the signal reflected by the discharged material is within a predetermined interval.

Furthermore, the road machine according to the invention may be structured in such a manner that the Doppler displacement can only be measured provided the signal reflected by the discharged material is reflected in a predetermined direction.

The transmitter/receiver means may comprise a directive antenna, such a a horn antenna, for ensuring sensitivity in a specific direction.

The invention relates also to a verifying device to be placed on a road machine for preventing slippery roads, said verifying device comprising a means for discharging and spreading material for preventing slippery roads. The verifying device is characterised in that for the prevention of slippery roads, it comprises a transmitter/receiver means for microwaves and a signal processing circuit, which in response to the received signal can detect the presence of discharged material moving in a desired direction and within a predetermined space. The resulting device is very durable for verifying the discharge function of a road machine.

### BRIEF DESCRIPTION OF THE DRAWINGS

The invention is explained in greater detail below with reference to the accompanying drawings, in which

FIG. 1 illustrates the rearmost portion of a road machine according to the invention with a rotatable disc for spreading the material to be discharged, and a device for verifying the discharge function,

FIG. 2 illustrates on a larger scale the spreading disc with the verifying device,

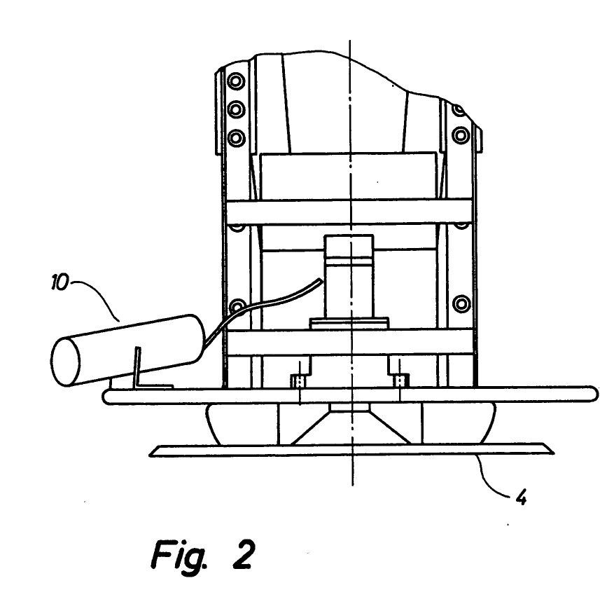

FIG. 3 shows a flow chart of the verifying device comprising a microwave transmitter/receiver means, and

FIG. 4 shows a horn antenna associated with the transmitter/receiver means.

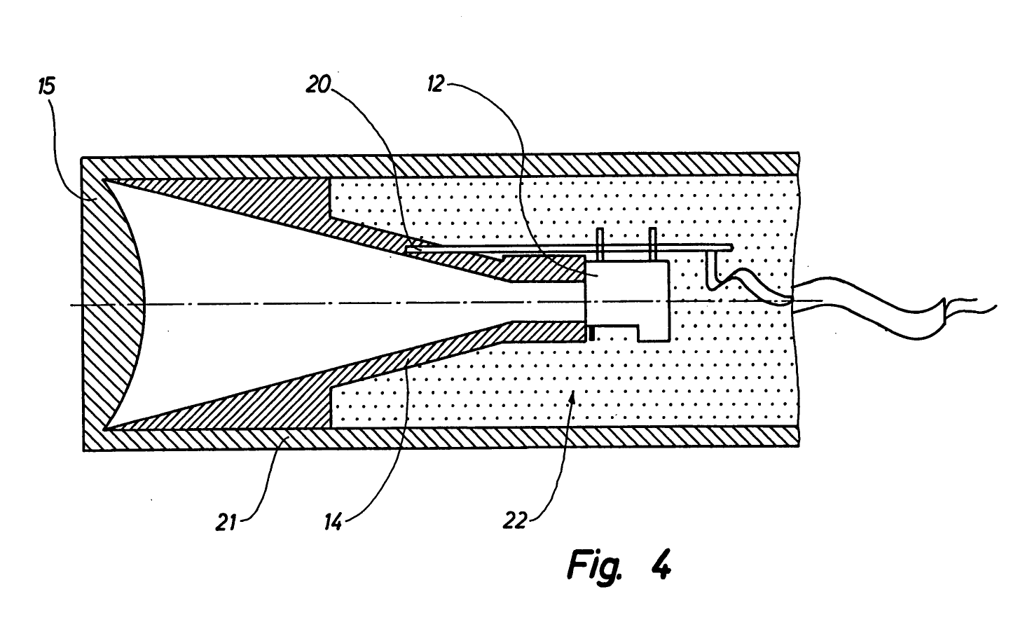

### BEST MODE FOR CARRYING OUT THE INVENTION

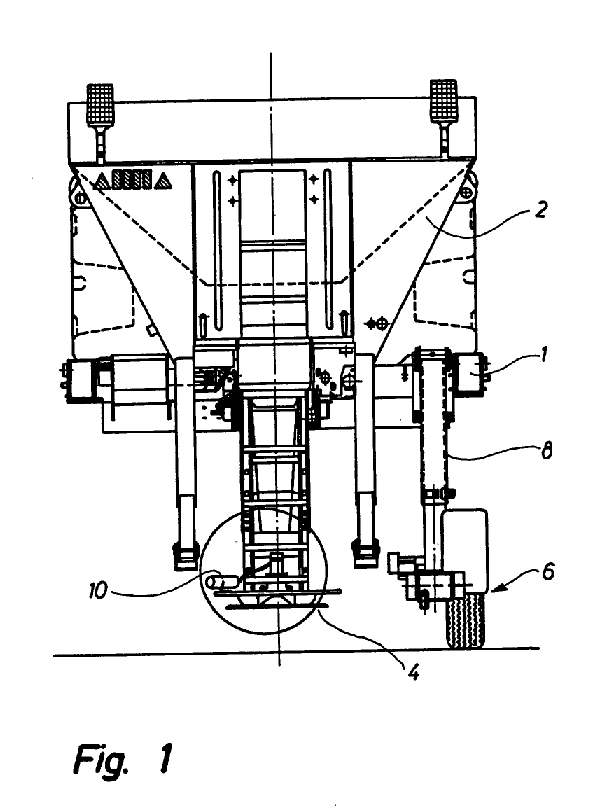

FIG. 1 illustrates a spreading device which can be placed on the rearmost portion of a lorry. The spreading device comprises a fixed frame 1, a material container 2 being placed on said frame 1. The material is distributed inside the container 2 by means of a stirring roll (not shown) accommodated inside said container 2, whereafter the material is advanced to a dispensing unit placed below said container 2. The material is dispensed from the dispensing unit onto a conveyor belt (not shown) advancing said material to the rearmost portion of the frame 1, where it is subsequently discharged by means of a spreading disc 4 secured to said frame 1.

A driving wheel 6 acts as driving source for the stirring roll, the dispensing unit and the spreading disc 4, said driving wheel 6 being arranged at the rearmost end of the frame 1 where it can be pressed downwards towards the road surface. The driving wheel 6 is carried by one end of a suspension arrangement 8, the opposite end of which is connected to the lower end of a column. The column is displaceable in its own direction and is permanently connected to the frame 1. Hydraulics or a separate motor can optionally be used as driving source for displacement of the column.

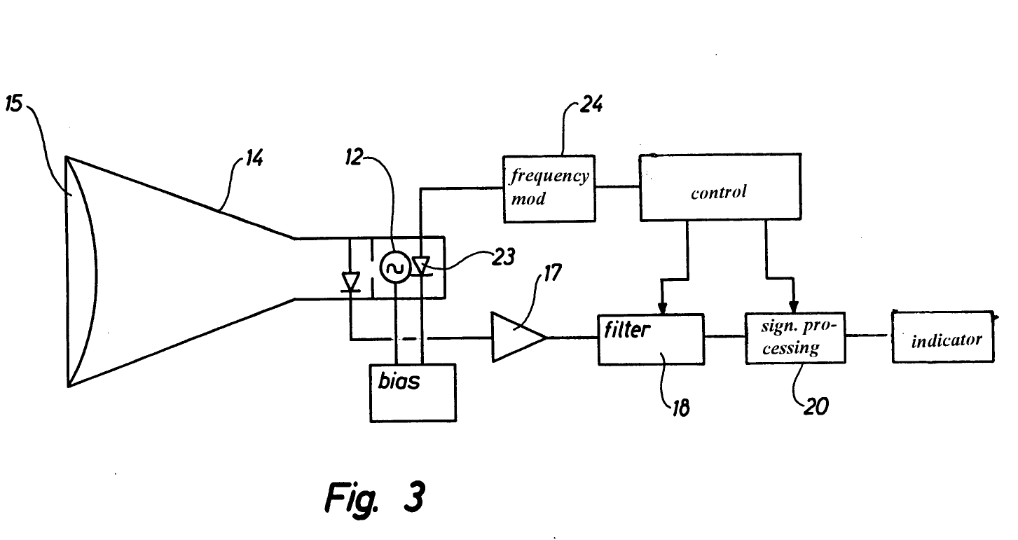

A device for verifying the spreading is arranged above the spreading disc 4 and comprises a microwave transmitter/receiver means 10. The microwave transmitter/receiver means 10 is arranged such that it is directed towards the material being discharged from the spreading disc 4. The microwave transmitter/receiver means 10 is shown in greater detail in FIG. 3. It comprises a microwave generator 12 which is adapted to generate microwave signals at a frequency of approximately 24 GHz. The microwave signal is generated in an element inserted in the neck section of a horn antenna 14. The horn antenna 14 adapts the impedance of the generator 12 to the radiation into the air. The horn antenna 14 presents furthermore the advantage that it is directive, viz. it is directional. The main radiation loop of the horn antenna is typically of a width of approximately 11°. The horn antenna 14 can be of a rectangular or circular cross section. In addition, the horn antenna 14 can be terminated by a focusing lens 15 which serves to increase the directional effect and to protect the interior parts of the horn antenna 14. As a result it is possible to increase the sensitivity in the measuring zone and to minimize the sensitivity towards remote and irrelevant reflections.

A detector in form of a semiconductor diode 16 is mounted in front of the microwave generator 12 in the neck section of the horn antenna 14. The semiconductor diode 16 is a non-linear element mixing the signal reflected by the material being discharged with the signal from the generator 12. The resulting signal is of a frequency corresponding to the difference between the signal generated by the generator 12 and the signal reflected by the material being discharged, said latter signal having been subjected to a frequency change, viz. a Doppler displacement, corresponding to the speed of the material being discharged. Then the frequency change represents a measurement of the speed of the material being discharged, said speed typically being 2.5 to 15 m/sec at spreading widths of from 2 to 12 m. As a result, the Doppler signals are between 400 Hz and 2.4 kHz. The signal indicating the frequency change is transmitted to an amplifier 17, which increases the signal intensity to a suitable level, and then to a band-pass filter 18 serving to exclude irrelevant signals which cannot derive from the reflection of the material being discharged. The filtered signal is transmitted to a signal processing unit 20 serving inter alia to ensure that only signals of a predetermined duration are transmitted to an indicator which in turn indicates that the discharge function is in order. The latter can optionally be registered in such a manner that subsequently a documentation is found for the fact that the discharge function has been in order at a specific time and optionally at a specific location. A varactor diode 23 for frequency modulation at 24 of the signal generated by the generator 12 can optionally be arranged in connection with the generator 12.

According to a specific embodiment, the horn antenna 14 is of a length of 12.6 cm and a diameter of 6.0 cm at the opening, which results in a beam width of approximately 11°. The horn antenna 14 is arranged inside a plastic housing 21, a moulding material 22 being inserted between the plastic housing 21 and the horn antenna 14. A circuit board for the signal processing circuit 20 is provided in connection with the neck section of the horn antenna 14.

The antenna can optionally be formed by means of an elliptic reflector, where the signal source is arranged in one focal point and the transmitted signals upon the reflection are focussed in the second focal point.

The transmitted signal can optionally be subjected to a frequency modulation in such a manner that only particles moving in a specific direction are registered.

The discharged material is formed by particles, optionally very fine particles or fluid particles.

If desired, the sensitivity can be adjustable, preferably from the factory.

1. Road machine for preventing slippery roads and comprising a means for discharging and spreading material for preventing slippery roads as well as a transmitter/receiver device (10) for microwaves including signal processing means for verifying the discharge function, characterised in that the transmitter/receiver means (10) is provided with a directional antenna so as to detect particles having a specific direction and is adapted to perform a Doppler measurement of the signal reflected by the optionally discharged material, if the Doppler displacement is within a predetermined interval so as to detect particles having a speed within a predetermined interval.

2. Road machine as claimed in claim 1, characterised in that the directional antenna is formed by a horn antenna (14).

3. Road machine as claimed in claim 2, characterised in that the horn antenna (14) is provided with a focusing lens (15).

4. Road machine as claimed in claim 1, characterised in that the transmitter/receiver means (10) comprises an elliptic reflector.

5. Road machine as claimed in one or more of the preceding claims, characterised in that the discharged material is formed by particles, optionally fluid particles.

6. Verifying device to be placed on a road machine for preventing slippery roads and comprising a means for discharging and spreading material for preventing slippery roads and a transmitter/receiver means (10) for microwaves including signal processing means for verifying the discharge function, characterised in that the transmitter/receiver means (10) is provided with a directional antenna so as to detect particles having a specific direction and is adapted to perform a measurement of the Doppler displacement of the signal reflected by the optionally discharged material, if the Doppler displacement is within a predetermined interval so as to detect particles having a speed within a predetermined interval.
